(19) United States
(12) Patent Application Publication
(10) Pub. No.: US 2014/0351743 A1
(43) Pub. Date: Nov. 27, 2014

(54) METHOD AND SYSTEM FOR SUBSCRIBING READING FEED

(71) Applicant: TENCENT TECHNOLOGY (SHENZHEN) COMPANY LIMITED, Shenzhen (CN)

(72) Inventors: Tingyong TANG, Shenzhen (CN); Bo HU, Shenzhen (CN); Huijiao YANG, Shenzhen (CN); Ruiyi ZHOU, Shenzhen (CN); Kai ZHANG, Shenzhen (CN); Bosen HE, Shenzhen (CN); Ying HUANG, Shenzhen (CN); Yulei LIU, Shenzhen (CN); Wei LI, Shenzhen (CN); Cheng FENG, Shenzhen (CN); Xi WANG, Shenzhen (CN); Zhengkai XIE, Shenzhen (CN); Zhipei WANG, Shenzhen (CN); Renfang LIU, Shenzhen (CN)

(73) Assignee: TENCENT TECHNOLOGY (SHENZHEN) COMPANY LIMITED, Shenzhen (CN)

(21) Appl. No.: 14/457,327

(22) Filed: Aug. 12, 2014

Related U.S. Application Data
(63) Continuation of application No. PCT/CN2014/072954, filed on Mar. 6, 2014.

(30) Foreign Application Priority Data
Mar. 6, 2013 (CN) 201310069986.3

(51) Int. Cl. G06F 17/30; G06F 3/0482; G06F 3/0484

(52) U.S. Cl. CPC G06F 17/30864; G06F 17/30675; G06F 3/0484; G06F 3/0482
USPC 715/780

(57) ABSTRACT

Embodiments of the present disclosure disclose a method and system for subscribing reading feed. One of the method includes: detecting a subscription keyword command input by user from a reading software interface; the terminal responds to the subscription keyword command, and outputs a keyword subscribing interface; detecting a keyword input by user from the subscription keyword interface; searching a reading resources corresponding to the keyword from the reading feed associated with a reading software, and outputting the reading resources corresponding to the keyword; detecting the reading resources chosen by user from the output reading resources corresponding to the keyword, and generating the chosen reading resources to reading feed. Embodiments of the present disclosure can not only accurately provide the reading resources that users are interested in, but also enhance the users' enthusiasm for using the reading software.

### CROSS REFERENCE TO RELATED APPLICATIONS

This application is a U.S. continuation application under U.S.C. §111(a) claiming priority under U.S.C. §§120 and 365(c) to International Application No. PCT/CN2014/072954, filed on Mar. 6, 2014, which claims the priority benefit of Chinese Patent Application No. 201310069986.3, entitled “METHOD AND SYSTEM FOR SUBSCRIBING READING FEED” and filed on Mar. 6, 2013, the content of which is hereby incorporated in its entire by reference.

### FIELD OF THE INVENTION

The present disclosure relates to internet technology, and more particularly to a method and system for subscribing reading feed.

### BACKGROUND OF THE INVENTION

Generally, the users will click a reading feed Add button, if they want to subscribe a reading feed of the reading software (eg, Fine Reading) in a mobile phone. Then users are classification search for the reading feeds associated with the reading software. Users finally found the satisfied reading feed for subscribing. The major limitation is that the classification of the reading feed is preset. Users can not subscribe freely according to their own interests. So the reading software is incapable of providing the reading resources that users are interested in. Thereby that will reduce enthusiasm of users, when users are using the reading software.

### DISCLOSURE OF THE INVENTION

The embodiments of the present disclosure provide a method and system for subscribing reading feed. The method and system for subscribing reading feed are directed to solve one or more problems set forth above and other problems, so that the reading resources that users are interested in can be provided accurately, and enthusiasm of users using the reading software can enhance.

The technical solutions provided by the embodiments of the present disclosure include the following.

A method for subscribing reading feed provided by the embodiments of the present disclosure in the first aspect, includes:

Detecting the subscription keyword command input by user from the reading software interface;

Responding to the above subscription keyword command, and outputting the subscription keyword interface;

Detecting the keyword input by user from the above subscription keyword interface;

Searching the reading resources corresponding to the keyword from the above reading feed associated with the reading software, and outputting the above reading resources corresponding to the keyword;

Detecting the reading resources chosen by user from the output reading resources corresponding to the keyword, and generating a reading feed from the reading resources chosen by user.

A system for subscribing reading feed provided by the embodiments of the present disclosure in the second aspect includes the following:

The first detecting unit, which is used for detecting the subscription keyword command input by user from the reading software interface, and informing the first responding unit;

The above first responding unit, which is used for responding to the above subscription keyword command, and outputting the subscription keyword interface;

The second detecting unit, which is used for detecting the keyword input by user from the subscription keyword interface, and informing the searching unit;

The above searching unit, which is used for searching the reading resources corresponding to the keyword from the above reading feed associated with the reading software, and outputting the above reading resources corresponding to the keyword;

The third detecting unit, which is used for detecting the output reading resources chosen by user from the above reading resources corresponding to the keyword, and informing the generating unit;

The above generating unit, which is used for generating the reading feed from the chosen reading resources;

According to the embodiments of the present disclosure, the above system will output a subscription keyword interface responding to a subscription keyword command, if the system detects the subscription keyword command input by user from the reading software interface. The system will search the reading resources corresponding to the keyword from the reading feeds associated with the reading software, and then the system output the reading resources corresponding to the keyword When the system detects that the user has chose the reading resources from the output reading resources corresponding to the keyword, the system generates a reading feed from the reading resources chosen by user. In this manner, the system can not only accurately provide the reading resources that users are interested in but also enhance users' enthusiasm for using the reading software.

### BRIEF DESCRIPTION OF THE DRAWINGS

Other aspects, features, and advantages of this invention will become apparent from the following detailed description when taken in conjunction with the accompanying drawings, which are a part of this disclosure and which illustrate, by way of example, principles of this invention.

FIG. 1 is an exemplary flowchart of a method for subscribing reading feed, in accordance with an embodiment of the present disclosure;

FIG. 2 is an exemplary flowchart of another method for subscribing reading feed, in accordance with an embodiment of the present disclosure;

FIG. 3 is a modularization schematic diagram of a subscribing reading feed, in accordance with an embodiment of the present disclosure;

FIG. 4 is a block diagram of a system for subscribing reading feed, in accordance with an embodiment of the present disclosure;

FIG. 5 is a block diagram of another system for subscribing reading feed, in accordance with an embodiment of the present disclosure.

### DETAILED DESCRIPTION OF ILLUSTRATED EMBODIMENTS

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The technical solutions provided by the embodiments of the present disclosure is to provide a method and system for subscribing reading feed, so that the reading resources that users are interested in can be provided accurately, and enthusiasm of users using the reading software can enhance. The following states respectively in detail.

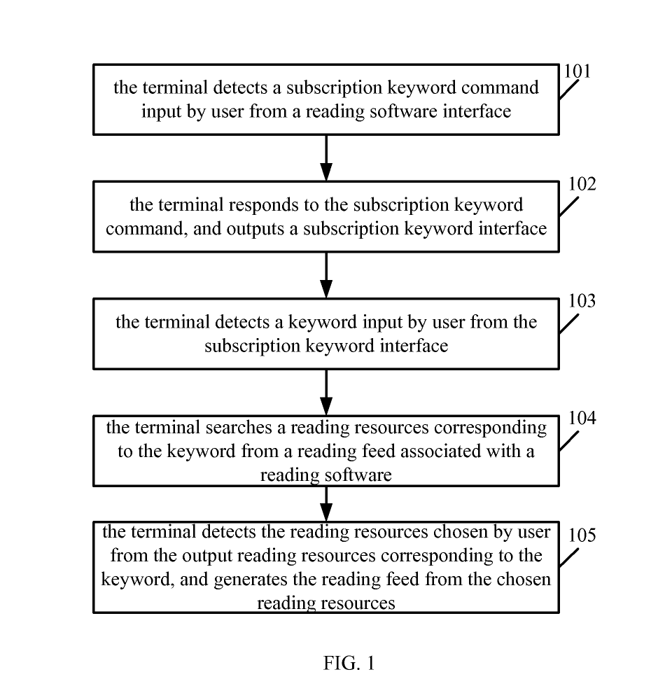

FIG. 1 is an exemplary flowchart of a method for subscribing reading feed, in accordance with an embodiment of the present disclosure. The method for subscribing reading feed shown in FIG. 1 can be applied to various terminal equipments, such as mobile phones, PDA (Personal Digital Assistant), tablet computers and other MID (Mobile Internet Devices), and so on. There is no limitation in this embodiment of the present disclosure. In this embodiment, the method for subscribing reading feed shown in FIG. 1 includes the following steps.

Step 101, the terminal detects a subscription keyword command input by user from a reading software interface.

In this embodiment, the reading software of the terminal can includes various reading software (eg, Fine Reading) about information, magazines, books, and so on. There is no limitation in this embodiment of the present disclosure.

In the embodiments of the present disclosure, the reading software interface of the terminal can set a subscription keyword button, thus the user can input a subscription keyword command to the terminal when clicking the subscription keyword button. Accordingly, the terminal can detect the subscription keyword command input by user from the subscription keyword button in the reading software interface. In practice, the subscription keyword command can be represented by high level signal, low level signal or other level signals, there is no specific limitation in this embodiment.

Step 102, the terminal responds to the subscription keyword command, and outputs a subscription keyword interface.

In this embodiment, the subscription keyword interface output by the terminal is mainly configured to input the keyword by user. In practice, the keyword interface of the terminal can show the history keywords input by user, thus the user can choose the history keywords rapidly and conveniently, without repeat operation for manually inputting the keyword by user.

Step 103, the terminal detects a keyword input by user from the subscription keyword interface.

Step 104, the terminal searches a reading resources corresponding to the keyword from a reading feed associated with a reading software.

In this embodiment, the reading feed associated with the reading software is usually preset. In addition, when the terminal is setting a new reading feed, the new reading feed belongs to a kind of reading feed of associated the reading software.

In this embodiment, the reading resources corresponding to the keyword include the reading feed with the title containing the keyword and/or the reading content of the reading feed including the keyword

For example, assuming the keyword is “Olympic Games”, when the title of a reading feed contains “Olympic Games”, the reading feed of the title contains “Olympic Games” can be considered as the reading resource corresponding to “Olympic Games”, of which, all reading content of the reading feed with the title containing “Olympic Games” is defined to use as the default reading material that user inputs keyword “Olympic Games” is interested in.

For another example, assume “Olympic Games” is the keyword. When one or more reading content contains “Olympic Games” of a reading feed, one or more reading content contains “Olympic Games” of the reading feed are considered as a reading resource corresponding to “Olympic Games”. Wherein, one or more reading content contains “Olympic Games” of the reading feed is defined to use as the default the reading material that user input the keyword “Olympic Games” is interested in.

Step 105, the terminal detects the reading resources chosen by user from the output reading resources corresponding to the keyword, and generates the reading feed from the chosen reading resources.

In this embodiment, the user can choose all or part of the reading resources from the output reading resources corresponding to the keyword, and generate the reading feed from the chosen reading resources in chronological order.

In the method for subscribing reading feed shown in FIG. 1, the terminal will output a subscription keyword interface responding to a subscription keyword command, if the terminal detects the subscription keyword command from the reading software interface by users. The terminal will search the reading resources corresponding to the keyword from the reading feeds associated with the reading software, and then the terminal outputs reading resources corresponding to the keyword, if the terminal detects the keyword input by user from the reading software interface. When the terminal detects that the user has chose the reading resources from the output reading resources corresponding to the keyword, the system generates a reading feed from the resource chosen by users. In this way, in the method for subscribing reading feed shown in FIG. 1, the terminal not only accurately provides the reading resources that the users are interested in but also enhance users' enthusiasm for using the reading software.

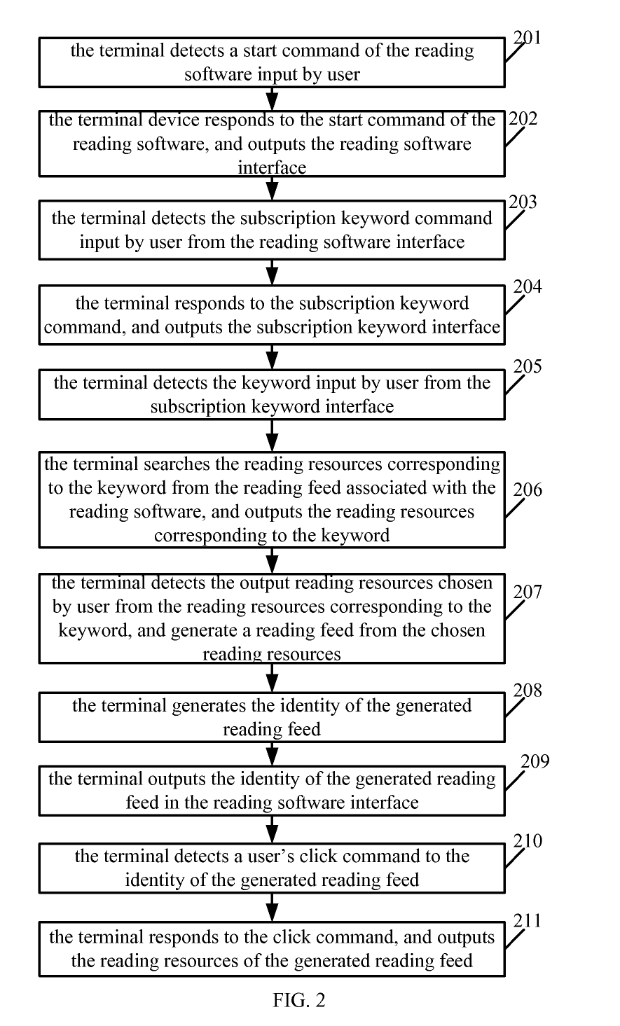

FIG. 2 is an exemplary flowchart of another method for subscribing reading feed, in accordance with an embodiment of the present disclosure. The method for subscribing reading feed shown in FIG. 2 is an optimized result of the method for subscribing reading feed shown in FIG. 1. In this embodiment, the method for subscribing reading feed shown in FIG. 2 includes the following steps.

Step 201, the terminal detects a start command of the reading software input by user.

In this embodiment, the user can click (such as double click) the reading software, and input the start command of the reading software to the terminal. Accordingly, the terminal can detect the start command of the reading software input by user from clicking the reading software. In practice, the start command of the reading software can be represented by high level signal, low level signal or other lever signals, there is no limitation in this embodiment.

Step 202, the terminal device responds to the start command of the reading software, and outputs the reading software interface.

In this embodiment, the reading software interface output by the terminal device can output the identity of the reading feed subscribed previously.

Step 203, the terminal detects the subscription keyword command input by user from the reading software interface.

In this embodiment, the terminal can detect the subscription keyword command input by user from the subscription keyword button setting on the reading software interface.

Step 204, the terminal responds to the subscription keyword command, and outputs the subscription keyword interface.

Step 205, the terminal detects the keyword input by user from the subscription keyword interface.

Step 206, the terminal searches the reading resources corresponding to the keyword from the reading feed associated with the reading software, and outputs the reading resources corresponding to the keyword.

Step 207, the terminal detects the output reading resources chosen by user from the reading resources corresponding to the keyword, and generate a reading feed from the chosen reading resources.

Step 208, the terminal generates the identity of the generated reading feed.

Step 209, the terminal outputs the identity of the generated reading feed in the reading software interface.

Step 210, the terminal detects a user's click command to the identity of the generated reading feed.

Step 211, the terminal responds to the click command, and outputs the reading resources of the generated reading feed.

In the method for subscribing reading feed shown in FIG. 2, the terminals can not only accurately provide the reading resources that users are interested in, but also enhance users' enthusiasm for using the reading software. In addition, the method for subscribing reading feed shown in FIG. 2 can actualize the individuation subscribing reading feed for users, thus can enrich the classification of the reading feed.

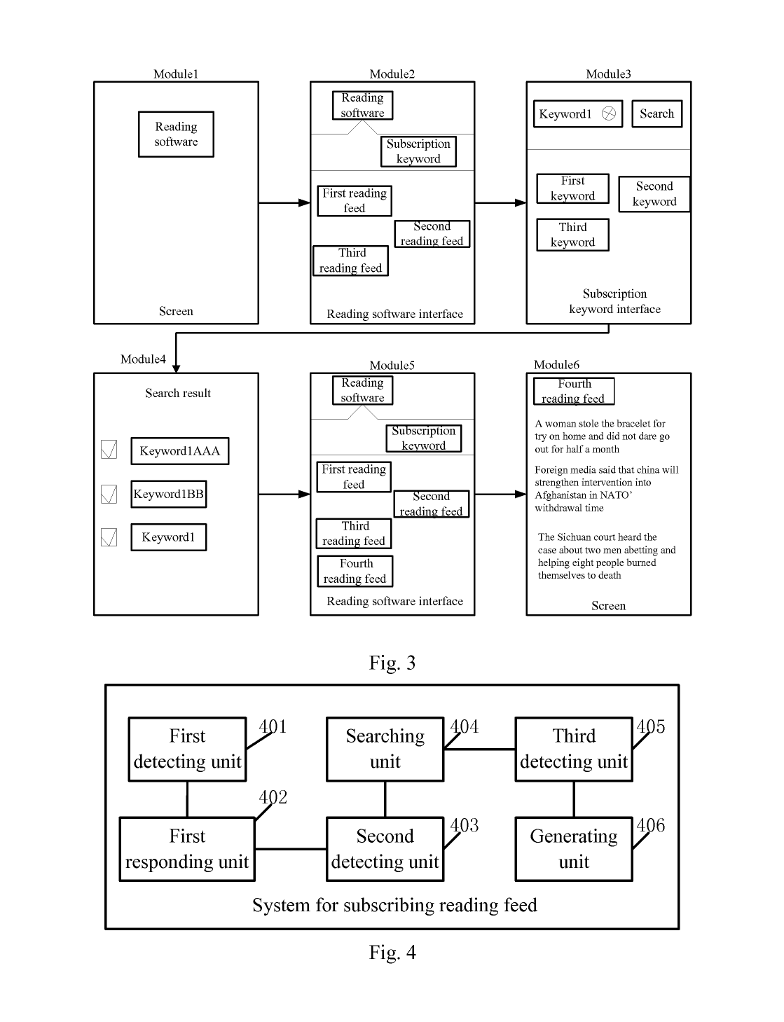

FIG. 3 is a block schematic diagram of a subscribing reading feed, in accordance with an embodiment of the present disclosure. The embodiment shown in FIG. 3 takes the Fine Reading as reading software to introduce the present disclosure in detail. As shown in FIG. 3, the block schematic diagram of the subscribing reading feed includes the following modules.

In Module 1: the terminal detects the start command of the reading software input by user from clicking the reading software (e.g. Fine Reading), and responds to the start command of the reading software, and outputs the reading software interface (e.g. Fine Reading interface).

In Module 2: the terminal detects the subscription keyword command input by user from clicking the reading software interface (e.g. Fine Reading interface), and responds to the subscription keyword command, and outputs the subscription keyword interface.

In this embodiment, the Fine Reading interface output by the terminal can also output the identity of the reading feed subscribed previously. For example, the identities of these reading feeds can include “the first reading feed (e.g. The 36 Krypton)”, “the second reading feed (e.g. Post of Military Situation)”, “the third reading feed (e.g. News and Entertainment)”, and so on.

In this embodiment, the reading software interface (e.g. Fine Reading interface) of the terminal sets up a “subscription keyword” button. When the “subscription keyword” button is clicked, the user can input the subscription keyword command to the terminal. Accordingly, the terminal can detect the subscription keyword command input by user from the “subscription keyword” button which is set up in the reading software interface (e.g. Fine Reading interface).

In this embodiment, the subscription keyword interface output by the terminal is mainly used for user to input keyword In practice, the subscription keyword interface output by the terminal can also display the history keywords input by user. In this way, the user can chose the history keywords rapidly and conveniently, without repeat operation for manually inputting the keyword by user.

For example, the history keyword displayed in the subscription keyword interface can include “the first keyword (e.g. the Deep Sea Mission)”, “the second keyword (e.g. Hot Sale on TaoBao)” and” the third keyword (e.g. 56 Video)”, and so on.

In Module 3: the terminal detects “keyword 1 (e.g. Phoenix)” input by user from the subscription keyword interface, and the terminal searches the reading resources corresponding to “keyword 1 (e.g. Phoenix)” from the reading feed associated with the reading software (e.g. Fine Reading), and outputs the reading resources corresponding to “keyword 1 (e.g. Phoenix)”.

In this embodiment, the terminal can search the reading resources such as “keyword 1AAA link (e.g. Phoenix Military link)”, “keyword 1BB link (e.g. Phoenix V video link)” and “ keyword 1 (e.g. Phoenix)” website link corresponding to “keyword 1 (e.g. Phoenix)”. Furthermore, the terminal can output the reading resources such as “keyword 1AAA link (e.g. Phoenix Military link)”, “keyword 1BB link (e.g. Phoenix V video link)” and “keyword 1 (e.g. Phoenix)” website link corresponding to “keyword 1 (e.g. Phoenix)”.

In Module 4: the terminal detects the reading resources chosen by user from the output reading resources corresponding to “keyword 1 (e.g. Phoenix)”, and generates the reading feed from the chosen reading resources, and generates the identity (i.e. the fourth reading feed) of the generated reading feed, and outputs the identity (i.e. the fourth reading feed) of the generated reading feed in the reading software interface (e.g. Fine Reading interface).

In this embodiment, when the reading resources such as “keyword 1AAA link (e.g. Phoenix Military link)”, “keyword 1BB link (e.g. Phoenix V video link)” and “keyword 1 (e.g. Phoenix)” website link corresponding to “keyword 1 (e.g. Phoenix)” was chosen by user, the terminal can detect the reading resources such as “keyword 1AAA link (e.g. Phoenix Military link)”,“keyword 1BB link (e.g. Phoenix V video link)” and “keyword 1 (e.g. Phoenix)” website link corresponding to “keyword 1 (e.g. Phoenix)” chosen by user. Furthermore, the terminal can generate the reading feed from the reading resources such as “keyword 1AAA link (e.g. Phoenix Military link)”, “keyword 1BB link (e.g. Phoenix V video link)” and” keyword 1 (e.g. Phoenix)” website link corresponding to “keyword 1 (e.g. Phoenix)”, and generate the identity “the fourth reading feed” of the generated reading feed, and output the identity “the fourth reading feed” of the generated reading feed in the reading software interface (e.g. Fine Reading interface).

In Module 5: the terminal detects the user's click command to the identity (i.e. the fourth reading feed) of the generated reading feed, and responds to the click command, and outputs the reading resources included in the generated reading feed.

In Module 6: displaying the reading resources included in the generated reading feed.

In this embodiment, after detecting the user's click command to the identity (i.e. the fourth reading feed) of the generated reading feed, the terminal can respond to the click command, and output the reading resources included in the generated reading feed.

For example, the generated reading feed can include the reading resources such as “a woman stole the bracelet for try on home and did not dare go out for half a month,” “Foreign media said that china will strengthen intervention into Afghanistan in NATO’ withdrawal time,” “the Sichuan court heard the case about two men abetting and helping eight people burned themselves to death”, and so on.

Through the modular process of the subscribing reading feed described in FIG. 3, the terminals can not only accurately provide the reading resources that users are interested in, but also enhance the users' enthusiasm for using the reading software. In addition, Through the modular process of the subscribing reading feed described in FIG. 3, we can actualize the individuation subscribing reading feed for users, thus can enrich the classification of reading feed.

FIG. 4 is a block diagram of a system for subscribing reading feed, in accordance with an embodiment of the present disclosure. In this embodiment, the system for subscribing reading feed can be applied to various terminals, such as mobile phones, PDA (Personal Digital Assistant), tablet computers and other MID (Mobile Internet Devices), and so on, there is no limitation in this embodiment of the present disclosure. As shown in FIG. 4, the system for subscribing reading feed includes a first detecting unit 401, a first responding unit 402, a second detecting unit 403, a searching unit 404, a third detecting unit 405 and a generating unit 406.

The first detecting unit 401 is configured to detect the subscription keyword command input by user from the reading software interface, and inform the first responding unit 402;

The first responding unit 402 is configured to respond to the subscription keyword command, and output the subscription keyword interface;

The second detecting unit 403 is configured to detect the keyword input by user from the subscription keyword interface, and inform the searching unit 404;

The searching unit 404 is configured to searching the reading resources corresponding to the keyword from the reading feed associated with the reading software, and output the reading resources corresponding to the keyword;

The third detecting unit 405 is configured to detect the reading resources chosen by user from the output reading resources corresponding to the keyword, and inform the generating unit 406;

The generating unit 406 is configured to generate the reading feed from the chosen reading resources.

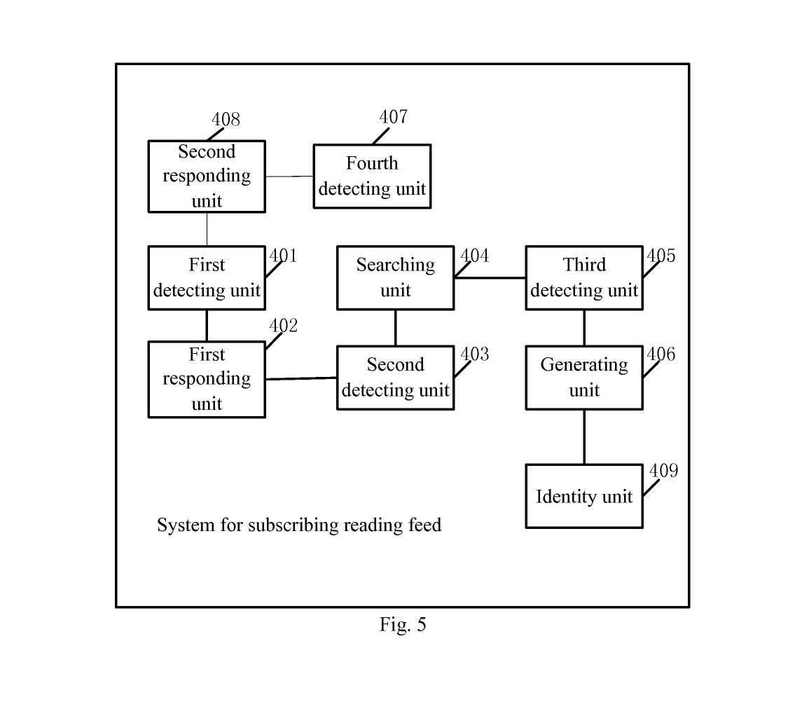

Please refer to FIG. 5, FIG. 5 is a block diagram of another system for subscribing reading feed, in accordance with an embodiment of the present disclosure. In this embodiment, the system for subscribing reading feed shown in FIG. 5 is an optimized result of the system for subscribing reading feed shown in FIG. 4. Compared with the system for subscribing reading feed shown in FIG. 4, the system for subscribing reading feed shown in FIG. 5 further includes the following units.

A fourth detecting unit 407 is configured to detecting the start command of the reading software input by user;

A second responding unit 408 is configured to respond the start command of the reading software, and output the reading software interface.

Compared with the terminal shown in FIG. 4, the terminal shown in FIG. 5 also includes the following units.

A identity unit 409 is configured to generate a identity of the generated reading feed, and output the identity of the generated reading feed in the reading software interface.

In the embodiments of the present disclosure, the fourth detecting unit 407 is also configured to detect the user's click command to the generated reading feed. Accordingly, the second responding unit 408 is also configured to respond the click command, and output the reading resources included in the generated reading feed.

In the embodiments of the present disclosure, the generating unit 406 is specifically configured to generate reading feed from the chosen reading resources in chronological order.

In the embodiments of the present disclosure, the reading resources corresponding to the keyword include the reading feed of which the title contains keyword and/or the reading content of which the reading feed contains keyword

In the embodiments of the present disclosure, the system for subscribing reading feed shown in FIG. 4, FIG. 5 can not only accurately provide the reading resources that users are interested in, but also enhance the users' enthusiasm for using the reading software. In addition, the system for subscribing reading feed described in FIG. 4, FIG. 5 can actualize the individuation subscribing reading feed for users, thus can enrich the classification of reading feed.

The methods, the server, the apparatus, and the system in accordance with various embodiments can be accomplished using a program/software to instruct related hardware. The hardware can include any suitable universal hardware, or any suitable specialized hardware including, e.g., specialized integrated circuits, specialized central processing unit (CPU), specialized memory, specialized components, etc. For example, the hardware can include personal computer, server, network device, etc. The program/software can be stored in a computer-readable storage medium including, e.g., ROM/RAM, magnetic disk, optical disk, etc.

The embodiments described above are merely preferred ones of the present disclosure but are not limitations to the protection scope of the present disclosure, and any variations or substitutions easily devised by those skilled in the art without departing from the spirit of the present disclosure fall within the scope of the protection. Therefore, the protection scope of the present disclosure shall be subject to that specified by the appended claims.

What is claimed is:

1. A method for subscribing reading feed, comprising:
detecting a subscription keyword command input by user from a reading software interface;
responding to the subscription keyword command, and outputting a subscription keyword interface;
detecting a keyword input by user from the subscription keyword interface;
searching a reading resources corresponding to the keyword from a reading feed associated with a reading software, and outputting the reading resources corresponding to the keyword;
detecting the reading resources chosen by user from the output reading resources corresponding to the keyword , and generating the reading feed from the chosen reading resources.

2. The method of claim 1, wherein before the step of the detecting a subscription keyword command input by user from a reading software interface, the method further comprising:
detecting a start command of the reading software input by user;
responding to the start command of the reading software, and outputting the reading software interface.

3. The method of claim 2, after the step of the detecting the reading resources chosen by user from the output reading resources corresponding to the keyword, and generating the reading feed from the chosen reading resources, comprising:
generating a identity of the generated reading feed; and,
outputting the identity of the generated reading feed in the reading software interface.

4. The method of claim 3, after the step of outputting the identity of the generated reading feed in the reading software interface, comprising:
detecting a user's click command to the identity of the generated reading feed;
responding to the click command, and outputting the reading resources of the generated reading feed.

5. The method of claim 1, the step of detecting the reading resources chosen by user from the output reading resources corresponding to the keyword, and generating the reading feed from the chosen reading resources further comprising:
generating the reading feed from the chosen reading resources in chronological order.

6. The method of claim 2, the step of detecting the reading resources chosen by user from the output reading resources corresponding to the keyword, and generating the reading feed from the chosen reading resources further comprising:
generating the reading feed from the chosen reading resources in chronological order.

7. The method of claim 3, the step of detecting the reading resources chosen by user from the output reading resources corresponding to the keyword, and generating the reading feed from the chosen reading resources further comprising:
generating the reading feed from the chosen reading resources in chronological order.

8. The method of claim 4, the step of detecting the reading resources chosen by user from the output reading resources corresponding to the keyword, and generating the reading feed from the chosen reading resources further comprising:
generating the reading feed from the chosen reading resources in chronological order.

9. The method of claim 5, wherein the reading resources corresponding to the keyword comprises the reading feed with the title containing the keyword and/or the reading content of the reading feed comprising the keyword.

10. The method of claim 8, wherein the reading resources corresponding to the keyword comprises the reading feed with the title containing the keyword and/or the reading content of the reading feed comprising the keyword.

11. A system for subscribing reading feed, comprising:
first detecting unit, configured for detecting the subscription keyword command input by user from the reading software interface, and informing a first responding unit;
first responding unit, configured for responding to the subscription keyword command, and outputting the subscription keyword interface;
second detecting unit, configured for detecting the keyword input by user from the subscription keyword interface, and informing a searching unit;
the searching unit, configured for searching the reading resources corresponding to the keyword from the reading feed associated with the reading software, and outputting the reading resources corresponding to the keyword;
third detecting unit, configured for detecting the reading resources chosen by user from the output reading resources corresponding to the keyword, and informing a generating unit;
the generating unit, configured for generating the chosen reading resources to reading feed.

12. The system of claim 11, further comprising:
a fourth detecting unit, configured for detecting the reading software start command of the reading software input by user;
a second responding unit, configured for responding to the start command of the reading software and outputting the reading software interface.

13. The system of claim 12, further comprising:
a identity unit, configured for generating a identity of the generated reading feed, and outputting the identity of the generated reading feed in the reading software interface.

14. The system of claim 13, further comprising:
the fourth detecting unit, configured for detecting the user's click command to the identity of the generated reading feed; and
the second responding unit, configured for responding to the click command, and outputting the reading resources included in the generated reading feed.

15. The system of claim 11, wherein the generating unit is configured for generating the chosen resources to reading feed in chronological order.

16. The system of claim 12, wherein the generating unit is configured for generating the chosen resources to reading feed in chronological order.

17. The system of claim 13, wherein the generating unit is configured for generating the chosen resources to reading feed in chronological order.

18. The system of claim 14, wherein the generating unit is configured for generating the chosen resources to reading feed in chronological order.

19. The system of claim 15, wherein the reading resources corresponding containing the keyword comprises the reading feed with the title contains keyword and/or the reading content of the reading feed comprising the keyword.

20. The system of claim 18, wherein the reading resources corresponding containing the keyword comprises the reading feed with the title contains keyword and/or the reading content of the reading feed comprising the keyword.
